(19) United States
(12) Patent Application Publication
(10) Pub. No.: US 2002/0179181 A1
(43) Pub. Date: Dec. 5, 2002

(54) Portable, lockable, folding work bench or tool table

(76) Inventor: William Charles Murphy, Nelson (CA)

Correspondence Address: William C. Murrphy, 411 Hamilton Ave., Nelson, BC, VIL 3G1, CA

(21) Appl. No.: 09/873,128

(22) Filed: Jun. 4, 2001

(51) Int. Cl. B25H 1/00

(52) U.S. Cl. 144/286.5

(57) ABSTRACT

Tradesmen such as maintenance men in apartment buildings, hospitals, motels, hotels, hobbyists and artists will find its many functions of great value. Also available will be a heavy duty model for farm, industry and military use.

TOOL TABLE consists of a large table top work area complete with a full length vise. Numerous holes to hold tools, bench dogs, hold down clamps etc. TOOL TABLE framework holds one large tool box and one open tray. When table is folded down on tool box, table, tool box and wheels can be securely locked in about one minute.

There are two models . . . A and B

Model A has 4 casters for great maneuverability in buildings.

Model B has a heavier framework and two large front wheels for moving wheel barrow fashion over rough ground or up and down stairs when folded. Also has two back casters.

Table top adaptations hold saver saw and router in vise jaws. Other adaptations include artist easel, rotating sculpture or pottery board, drawing and writing surfaces, pipe gripping jaws. The removable full table top length board has features to hold saber saw and odd shaped wood pieces in conjunction with the table long vise.

In folded down mode without tool box can be stored in a car trunk or other small space.

This invention relates to a portable, lockable, light, sturdy, maneuverable work bench of Tool Table. These features allow the Tool Table to be readily taken to the job sites. FIGS. 1 . . . 1A . . . 2 . . . 2A.

A workman is always at a disadvantage when out on a job because he can't have available all his tools or a sturdy work surface . . . also a safe place to lock up his tools when he has to leave. This Tool Table provides all of the above.

The advantages of the Tool Table are provided by the following:

1. A light, sturdy, foldable, lockable framework.

2. By using casters and wheels, table is very maneuverable even on rough ground or on stairways.

3. A large tool box and material tray fit into the bottom deck of the framework.

4. Tool box holds a wide variety of power tools and hand tools.

5. Too Table top is comprised of 3/4″ plywood and segmented to perform numerous functions.

6. Table top also has a full length vise operated by two detachable cranks, 2 pulley wheels on 2 crank shafts are joined by a belt, therefore cranking one crank moves both crank shafts . . . FIGS. 2 . . . 2A.

7. By using hand bar 19 . . . foot bar 17A and release bar 29 raising and lowering mechanism is quick and efficient. FIGS. 16 . . . and 16A

8. Controls for raising and lowering are simple, convenient and positive . . . FIGS. 8 . . . 16 . . . 16A

9. When Tool Table is folded down on tool box, table, box and wheels can quickly be locked FIG. 7.

The metal framework of the Tool Table consists of ¾″ iron square tube and ¾″ angle iron, moveable portions of the framework pivot about bolts and fixed portions are welded. This metal framework is designed to fold upon itself to facilitate moving about on front wheels, storage, locking too box and wheels FIGS. 3A . . . 6 . . . 7.

Two models will be available Model A with front and back lockable casters, for use in buildings and confined spaces because of its manouverability . . . Model B has large nonswivelling front wheels and a solid foot plate or back caster mechanism FIGS. 1 . . . 1A. is less maneuverable in confined spaces but much more maneuverable over rough ground and up and down stairs.

Table top consists of 6 pieces of full table top lengths of ¾″ plywood and 2 short pieces to be used in conjunction with router or saber saw FIG. 24. Tool Table top has numerous holes to hold hand tools, bench dogs, hold down clamps, etc. . . . FIGS. 18 . . . 23 . . . 24 . . . 25 . . . 26. Board 78 is removable, also holds a saber saw and pieces to be worked while held in vice jaws. The folding and unfolding mechanism is slightly different in Model A and B in foot bar use mainly FIGS. 16 and 16A.

The main releasing and locking device is shown in FIGS. 12 and 13 with a final safety locking done by tightening large wing nut 16 down on lock washer 57, shield 8 and leg 22. This device is activated by pulling on release bar 20 which pulls cord 14 over pulley 81 and raises slip fitting 13, raises diagonal brace bar 10, unlocking and allowing leg 22 to move FIGS. 12 . . . 13 . . . 17. The two large wing nuts provide positive safety locking of framework in up or down position.

The moveable jaw portion of the table top vise is moved right or left by turning cranks 3 FIGS. 26. Jaw board can hold against fixed board 76 on either side, also holds router and saber saw FIGS. 23 . . . 25. Turning hand crank 3 rotates crankshaft 40 which in turn moves along nut 48 right or left. This moves bolt 48B welded to nut 48 and therefore moves vise jaw board 77. Removal of board 78 allows vise jaw board to travel right or left to fixed boards 76. Crankshaft ends 40 ground square 40A protrudes through drop side leaf boards 5 allowing crank square tube 3A to fit over square end 40A Pulley 23 with belt moves pulley on second shaft at same time, jaws can be moved in parallel with board 76 or at an angle for unparallel work pieces. Nuts 49A and bearings 49 allow free rotation but prevent crankshaft from moving laterally. FIGS. 27 and 28.

Additional Tool Table lateral stability is provided by chains and turnbuckles. Back lets are stabilized by chains and turnbuckles 25. These, once set up need no further attention as they loosen and tighten automatically as framework moves up and down FIG. 29. Front legs stabilization is only needed for vigorous work such as using a hack saw, rasp, heavy chiseling, etc. It is accomplished by dropping chain 79A through front leg loops 79 and putting in pins 80 through loop 79 and chain 79A. Tighten turnbuckles FIG. 30. With casters, locked, table is now very rigid.

Mode B back caster 27, base plate 32 mechanism is activated by placing foot on foot bar 17A and forcing down and pulling back on hand bar at same time. This action raises caster 27 off the ground and puts leg 22 weight on base plate 32. “D” fitting 17 falls down over leg 18 and wedge 60 on leg 22. This action binds and locks leg 22 onto base plate 32. FIGS. 14 and 15.

Drop leaf wing boards are hollow and act as scabbards for two full size bandsaws. These boards provide 8″ additional table surface on each side when lying on pull out support bars 42 FIGS. 8 and 9.

On close examination it is evident Tool Table framework action is plain and simple and efficient for both Model A and Model B. Casters and wheels each providing separate but useful functions. The table top provides a stable surface of many uses and a platform for numerous accessories. Further relevant information will be revealed in studying the claims.

### DETAILED DESCRIPTION OF FIGURES AND FUNCTIONS

FIG. 1 . . . This view shows Tool Table in upright position and is Model A with four casters. Front casters 6 are lockable.

FIG. 2 . . . Model B view showing Tool Table in upright position, side drop wing raised 5 exposing pulleys 23 and belt 24 system. Tool box 21 and material tray 26 in place. Tool box 21 has lid 12 that can be raised and locked in open position. Lid 12 has 2 posts 22A to place two hand saw handles over when locking table down on box 21. Box 21 has interior partitions for separation of large tools such as saber saw, drill, level etc. and a full sized tray on top of partitions for small tools such as chisels, screw drivers, wrenches, etc. FIG. 2A also shows leg 18 in down position thereby raising back casters 27 off floor and making table stable and sitting on leg 18 adjustable base 32. Front wheels 28 of model B are 8″ diameter non swiveling, lockable and supported by framework 29 and 29A. FIG. 3. FIGS. 2 and 2A shows alternate construction system of hand bar 19 and foot bar 17A for raising and lowering table. Used in conjunction with wheel 28, tip down leg 18 and adjustable foot plate 32 offers a slightly more stable use on rough ground. Because of non swiveling wheels 28 this model is less maneuverable in confined spaces e.g. hallways or elevators, but much more maneuverable on rough ground and stairways.

FIG. 3 . . . Tool table now in folded position ready for storage in a car trunk or storage standing on front wheels 28 and table top front end in a small space. Table can easily be moved by grasping legs 22, lifting and moving about wheel barrow fashion. A similar action can be done using front casters 6 of model A FIG. 1. Using the alternate construction system, hand bar 19 and foot bar 17A as shown on FIGS. 1 and 2, table can be folded or unfolded with same ease as provided by hand bar 19 and foot bar 17A as shown in FIGS. 1A and 2A.

FIG. 4 . . . Model B in folded position ready for storage in horizontal or vertical position, or moving about wheel barrow fashion over rough ground or up and down stairs.

FIG. 5 . . . Model A in folded mode for storage with tool box 21 standing on table top end and caster frame 6.

FIGS. 6 . . . 7 . . . 7A . . . Table folded on tool box, chain 34 pulled from chain locker 33. Eye bolts 36 are tightened down on wheel tire 28 preventing rotation. Locking bar 35 now passed through right eye bolt 36, chain links pulled tight, through left eye bolt 36 then apply padlock 37 through hole 37A in end of locking bar 35.

FIG. 8 . . . Pulling on bar 20 tightens cord 14 over pulley 81 causing slip fitting 13 to raise diagonal brace bar 10 and unlocking table for folding. See FIGS. 12 and 13 for details. Diagonal chain and turnbuckles 25 are preset on assembly and need no altering. They provide excellent stabilizing. Pull brace bar 42 is one of two on each side and provide support for side drop wing boards 5. Crank handle 3 turns crank shaft 40 causing moveable jaw board nut 48 to travel right or left along threaded shaft 40. Shaft is supported through metal bearing 49 near each end.

FIG. 9 . . . Drop leaf wing boards 5 are hollow and act as scabbards for two full sized hand saws 46. one 2 foot square and one 36″ rule. Board 77 is moveable portion of full length vise controlled by detachable hand crank 3. Vertical surfaces of vise jaws are covered with sand paper for positive gripping. Electric power is supplied to the table by a 6 outlet power bar 45, table is lowered by gripping bar 19 with both hands and using the index finger on each hand pull on bar 20. This action releases the diagonal brace bar 10 locking mechanism. See FIGS. 12 and 13 for details.

FIG. 10 . . . Caster locked . . . Caster 6 is attached to leg 7 by bolt and lock nut 54. Also attached to caster 6 is plate 51. Eye bolt 38 when tightened down on caster 6 prevents any slack or swiveling. Caster wheel is locked by stepping down on locking lever 53. Locking bar 35 is passed through caster metal loop 52, chain link 34 and other caster loop 52 welded to caster props 39. Padlock 37 is attached to hole 37A at locking bar end. With locking bar 35 against back of locking lever 53 and through chain link 34 and caster metal loops 52, locking lever 53 cannot be moved or caster wheels unlocked.

FIG. 11 . . . Caster unlocked . . . By removing locking bar 35 and loosening eye bolt 38 allows caster 6 to swivel. With locking bar 35 removed caster locking lever 53 can be raised thus unlocking caster wheel. Caster prop bar 39 has caster metal loop 52 welded on and prop bar 39 bolted on to caster 6 body. Caster prop bar 39 protects caster locking lever 52 when standing table on front end. Prop bars 39 and metal loops 52 are additions to a regular hardware store caster.

FIGS. 12 and 13 . . . Tightening cord 14 causes slip fitting 13 to raise thus lifting diagonal brace bar 10 up off horizontal leg pin 56. This action allows . . . 22 . . . to tilt forward as locking notch 55 disengages from leg pin 56. Raising table causes diagonal brace bar 10 to slide up and notch 55 fall by gravity over and locking on the horizontal leg pin 56. Further locking is done by tightening wingnut 16 down on large washer 57 which spreads pressure over aluminum shield . . . 8 . . . and therefore evenly on to diagonal brace bar . . . 10 . . . and leg 22. Table is now securely locked in upright working position. Linkage 59 between slip fitting 13 and shield hole 58 keeps both in proper relation to each other.

FIGS. 14 and 15 . . . To take back table legs off casters 27 and put legs on solid base plate 32. Place foot on foot bar 17A (FIG. 16). Pull back on bar 19 leg 18 will become vertical lifting the caster 27 off the floor. This action causes D fitting 17 to fall down leg 18 by gravity over wedge 60 binding and removing all slack. Welded to base plate 32 is a bolt 62 that provides a leveling and locking feature by rotating foot plate 32. To put caster 27 back on floor remove D fitting . . . 17 . . . from D fitting clamp 61 and raise D fitting 17 up to short leg 18 top . . . Push table forwards and leg 22 will come off base plate 32 and down on to caster 27.

FIGS. 14A and 15A . . . An alternative method of back leg functions accomplished by using a locking caster 6 as used on front legs FIG. 1. To lock caster step on locking lever 53 and tighten eye bolt 38. This prevents all movement. To unlock flip up locking lever 53 and loosen eye bolt 38. The only addition to this hardware store caster is fastening plate 51 and eye bolt 38.

FIGS. 16 and 17 . . . Placing foot on foot bar 17 A forces legs 18 down and lifts castors 27 off the floor and locking automatically in vertical position by D fitting 17 falling down over wedge 60 and binding . . . FIGS. 14 and 15. Grasping hand bar 19 and with two fingers pull bar 20, this action tightens cord 14 lifting slip fitting 13 and therefore diagonal brace bar 10 and unlocking table for lowering. (see FIGS. 12 and 13). Ease hand bar 19 forward and table will fold on tool box 21 or on lower deck without tool box 21.

FIGS. 16A and 17A . . . Using locking casters 6 instead of FIG. 16 method a similar result is achieved with a modified structure of hand bar 19 and foot bar 17A.

FIGS. 18 and 19 . . . Using bench dogs 65 and working in conjunction with long table top vise jaws, boards to be worked can be firmly secured by using two hand cranks 3 and tightening jaws.

FIG. 20 . . . The 12×12×¾ inch board 66 has a center post located in the middle underneath. This post fits the table top holes so can be locked in many positions. Being free to rotate is a useful base for sculpture and pottery. Using a 20 inch diameter disc of arborite 44 fastened to the board 66 by two sided rug tape becomes a very useful surface for drawing and tracing FIG. 20A. There is ample friction between board 66 and table top to hold steady but still rotate.

FIGS. 21 and 22 . . . By using two dowels 67, two adjustable baseboards 68 with pegs 68A and table top holes an easel is quickly assembled at any angle using the front deck panel for an easel face 44A. Lying flat this easel face (front deck panel) converts to a table top writing or drawing surface FIG. 20B . . . being made secure by two velcro pieces attached underneath which hold two velcro patches 4 attached to raised and propped drop wing side boards 5 FIG. 20A

FIG. 23 . . . This view shows saber saw 71 attached to square panel 70 and being securely held by table top vise jaws. Also exposed is the chain locker 33 and chain 34. This chain is used in conjunction with the locking bar 35 (see FIG. 7) to securely lock table, tool box, and wheels. A router mounted on a similar square panel 70 can also be secured for use in jaws in table. Router and saber saw are controlled by a foot operated off/on switch, leaving hands free to hold work pieces.

FIG. 24 . . . This view shows saber saw mounted on panel 70 securely held in place by table top vice. Board 72 fills spaces left by panel 70 making table top one flat uninterrupted working space.

FIGS. 25 and 26 . . . This view shows table drop side wing boards 5. These boards are readily removed by unscrewing 2 wingnuts attached to hinges 2 on each board leaving room for accessory attachments such as a wood lathe, two boards 76 are attached solidly to table framework. Board 77 is moveable jaw portion of full length table top vice. Board 78 is removable board leaving space for jaw function. Jaw can now grip between either board 76 and is controlled from either side and either end by turning crank handles 3. Board 78 has numerous holes to put screws through from the underneath surface to hold odd shaped boards securely to board 78. Board 78 is then locked in table top vise. Once secured, belt sanding, routering, etc. can be done. Vise jaw board 77 and board 76 have a recessed area 73 to hold saber saw or routerplates 70 (FIG. 23). Removable board 78 has a recessed area underneath in which a saber saw can be fastened by bolts with blade passing up through a one inch hold in board 78. Mounting board 78 in vise jaw provides another way to work with the saber saw. Wire spool 75 rides on axle 74 passing through loop 79 and center of spool 75. With telescoping tube 74 can accommodate 3 spools. Axle and spools held in position by pins in holes in axle ends and through loop 79 and axle 74.

FIGS. 27 and 28 . . . These views show mechanism to move vise jaw board 77. By turning threaded crankshaft 40 nut 48 moves laterally right or left with board 78 removed. Shaft rides on bearings 49 and protrudes throughout dropside wing boards 5. Protruding portion of shaft is ground square 40A (FIG. 28). Crank handle 3 is attached to square tube 3A that fits over crankshaft end 40A Pulleys 23 on each shaft are joined by an elastic bungy cord belt. Therefore cranking one shaft moves both pulleys 23 and shafts 40. Non parallel vertical surfaces can be gripped as there is just enough slippage of belt to allow this action. Work can be held in position with one hand while cranking with the other then once in position tighten both cranks 3. Welded to nut 48 is a threaded bolt 48B that extends to moveable jaw viseboard 77. A countersunk nut 48C is fastened to 48B securing bolt 48B to jaw board 77.

FIG. 29 . . . Back legs 22 are made stable by tightening chain and tumbuckles 25. Once set, needs no further attention as they automatically stablize and release as able is raised and lowered.

FIG. 30 . . . Front legs 11 need only be stabilized when heavy work is to be done . . . example, using a rasp, hacksaw or vigorous chiseling etc. For most work table is stable enough without. Pass chain 79A through loop 79 and drop pin 80 through loop holes and chain on both legs. Tighten turnbuckles and table becomes very rigid with all wheels locked entire table is very stable.

FIGS. 31 and 32 . . . Pipe ¾ inch and under can be held by the regular table top vise jaws. Pipe over ¾ inch to 3 inch can be held by 4 wooden vise jaws FIG. 32, plugged into holes on fixed table top and vise jaw board. Turning crank handles tightens jaws on pipe for sawing.

### BRIEF DESCRIPTION OF FIGURES

FIG. 1 Side view of Model A Tool Table with side drop wing down. Vice jaw hand cranks visible, Model A has 4 casters.

FIG. 2 Side view of Model B complete with tool box and open tray. This model has 8″ non swiveling front wheels.

FIG. 3 Model B in collapsed position lifting back end can be moved around on the front wheels wheelbarrow fashion over rough ground and up or downstairs.

FIG. 4. In completely collapsed mode Model A and Model B can be easily stored in a car trunk or apartment clothes closet.

FIG. 5 Model A and B can be moved on front wheels or stored in upright standing position with or without tool box.

FIG. 6 Table collapsed on tool box in preparation to locking.

FIG. 7 Front view of table down on tool box, chain and locking bar in position with padlock.

FIG. 7A Part of front wheel locking system, eyebolt through frame and screwed tightly down on tire.

FIG. 8 View from underneath back of table showing crank shaft, vice jaw moving nut, crank handle, drop side wing support bar, chain and turnbuckle stabilizers, diagonal brace bar and locking device . . . see FIGS. 12 and 13 for details.

FIG. 9 Back view of Tool Table showing drop side wing down and hand saws in scabbard, electric power bar mounted on back wood frame, tool and clamp holes evident on table top.

FIG. 10 Model A front caster in locked position.

FIG. 11 Model A front caster in unlocked position.

FIG. 12 Diagonal brace bar in locked position.

FIG. 13 Diagonal brace bar in unlocked position.

FIG. 14 Back leg caster in unlocked position.

FIG. 15 Back leg caster in locked position.

FIG. 16 Back side view of table in upright position showing bars used to raise and lower table.

FIG. 17 Side view showing mechanism used to raise and lower diagonal brace locking bar and therefore the table.

FIG. 18 Table top showing function of vice clamping jaws tool holes and clamping bumpers.

FIG. 19 Bottom side view of clamping bumper.

FIG. 20 View showing square swivel board used for pottery, sculpture or used in conjunction with a 20″ diameter disc of arborite being very useful for drawing or tracing.

FIG. 21 View showing easel support dowels and adjustable easel base boards.

FIG. 22 View showing easel in place, made from front deck board. Board lying flat becomes writing surface held in place by velcro pads.

FIG. 23 View showing saber saw or router in place held securely by vice jaws . . . filler boards out chain locker also evident.

FIG. 24 Saber saw and filler boards in place.

FIG. 25 Front side view showing electricians wire spool in place . . . with a telescoping bar can accommodate 3 spools.

FIG. 26 Table top showing recessed space for saber saw and router, tool, bumper and clamp holes, hand crank handles and Velcro pads for holding writing desk board from front deck.

FIG. 27 Crank shaft, pulley and moveable vice jaw, nut and shaft.

FIG. 28 Detachable crank shaft handle that fits on square shaft end.

FIG. 29 View of back legs stabilizing t urn buckles and chain.

FIG. 30 View of front legs stabilizing turn buckles and chain. Electric wire spool axle loops and holding pins.

FIGS. 31 and 32

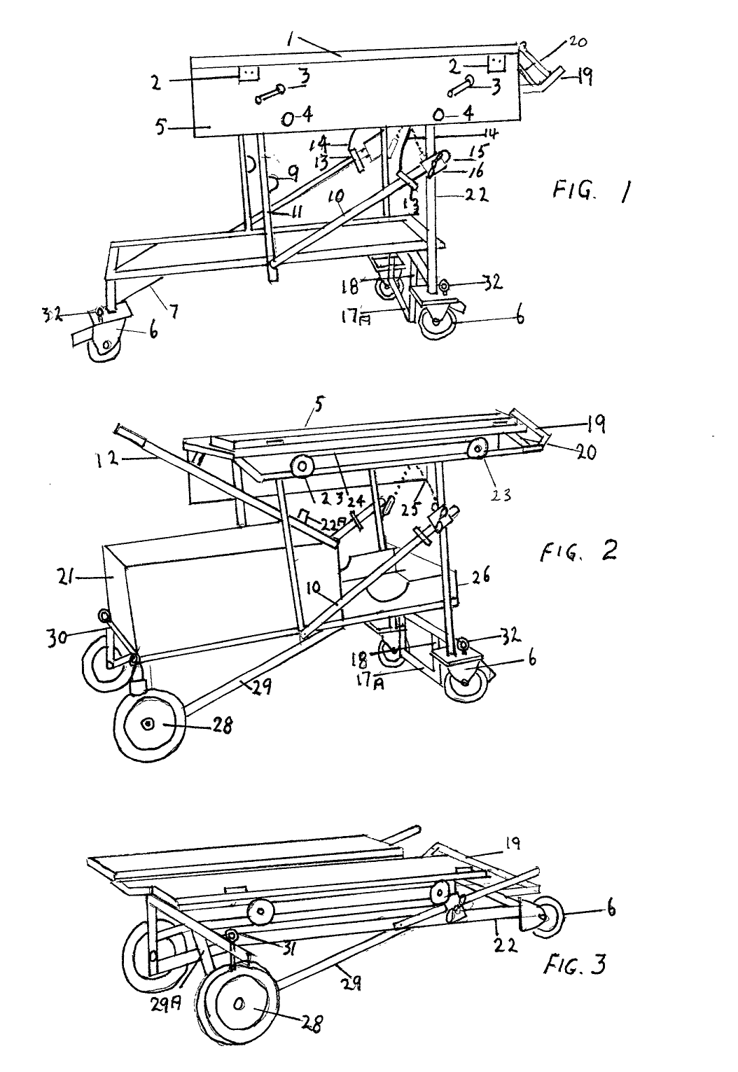

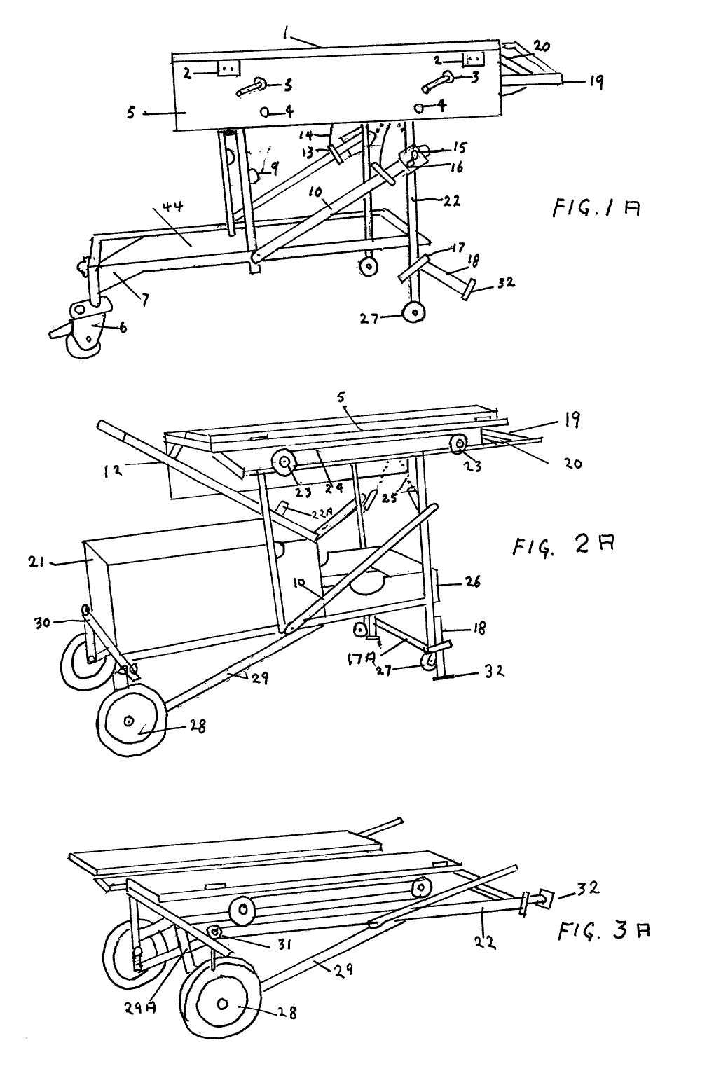

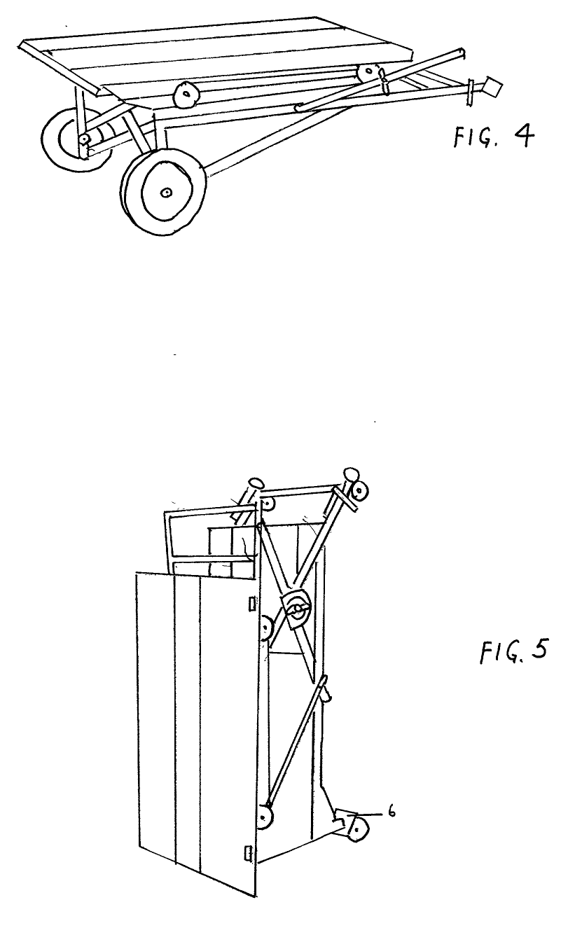

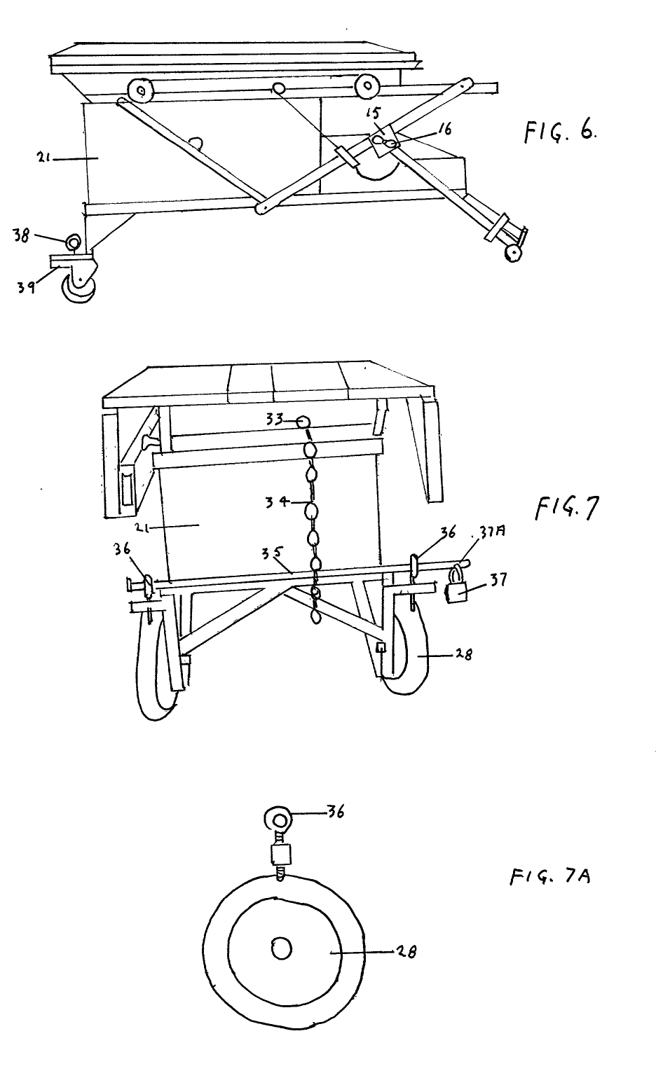

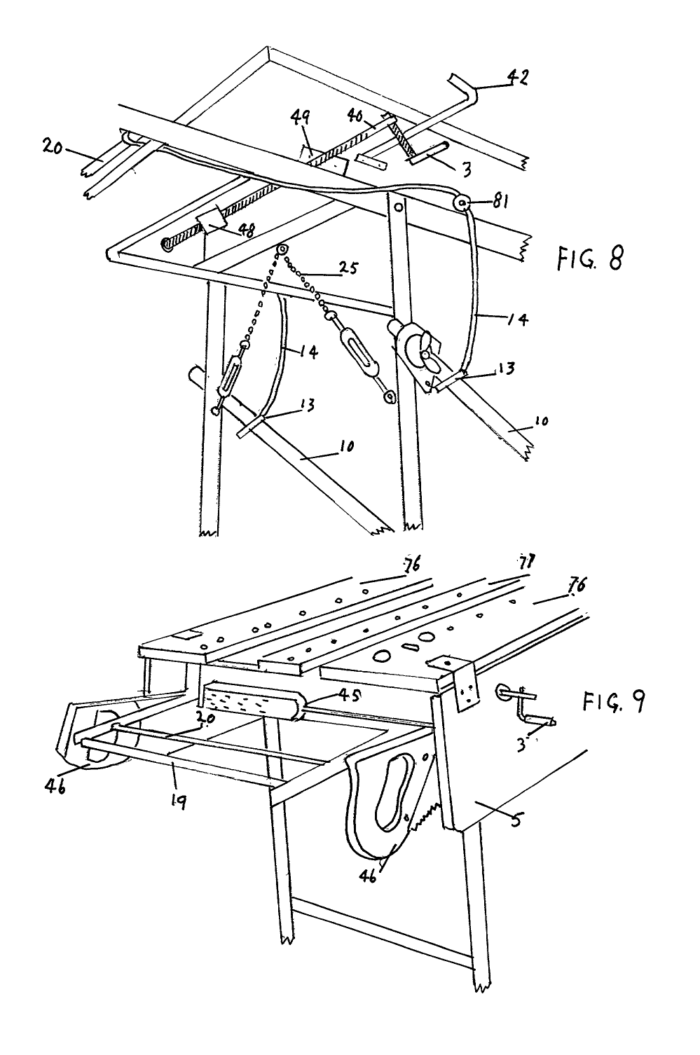

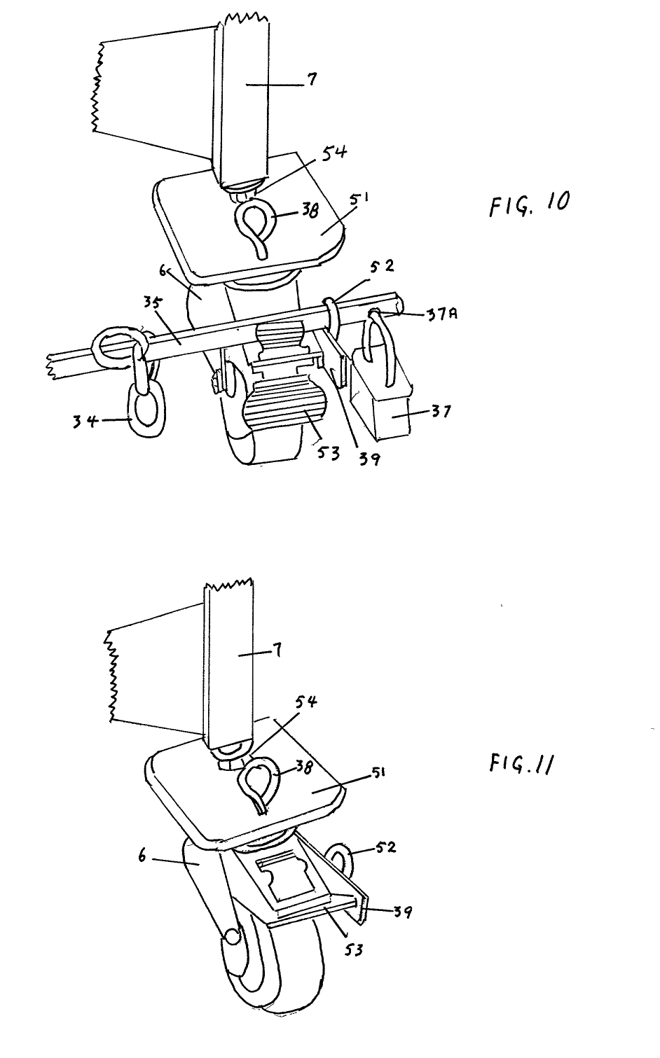

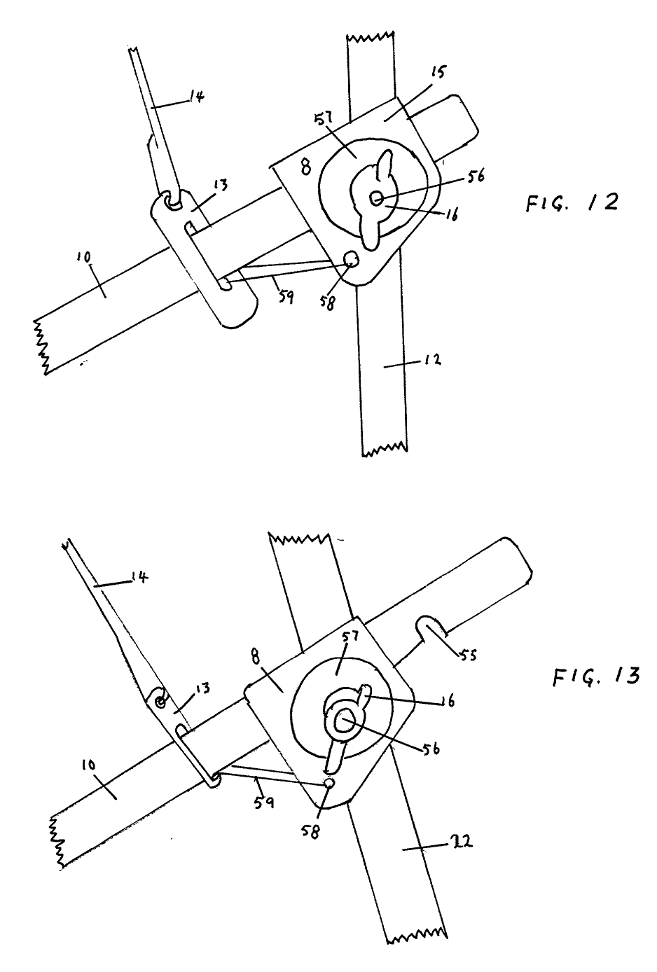

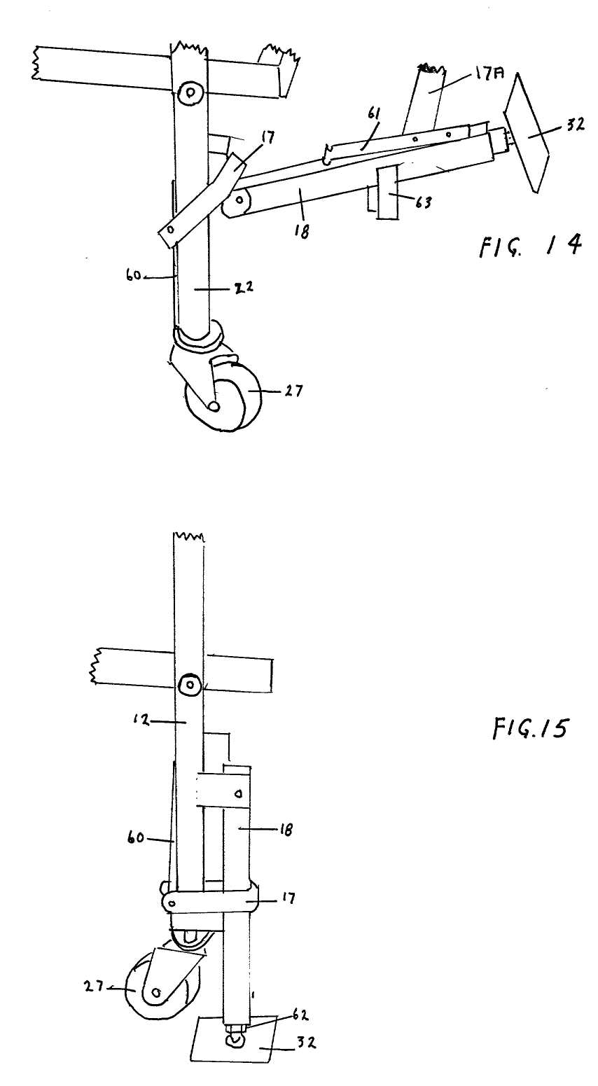

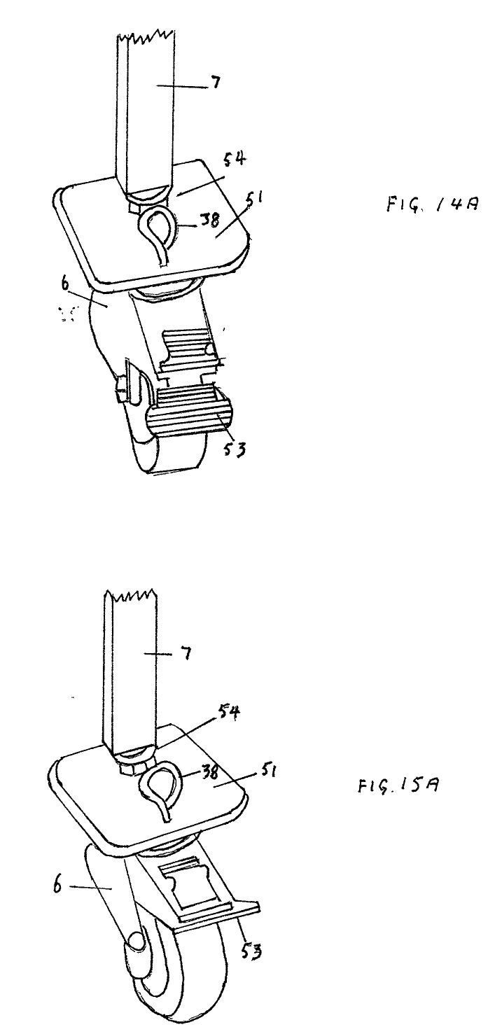

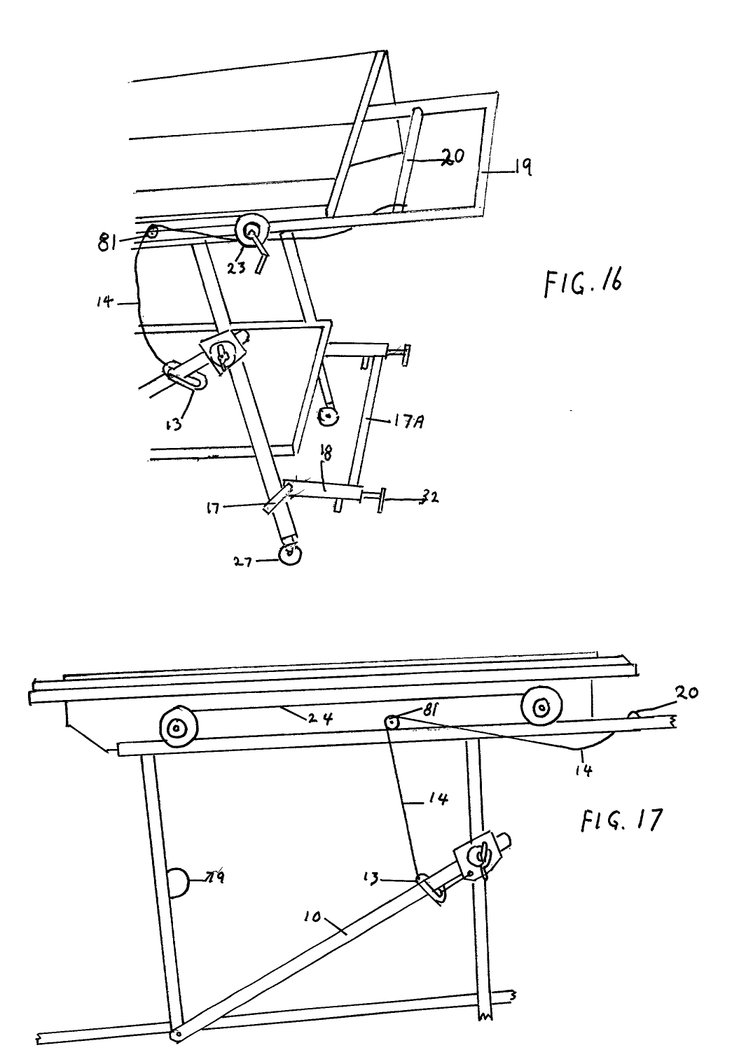

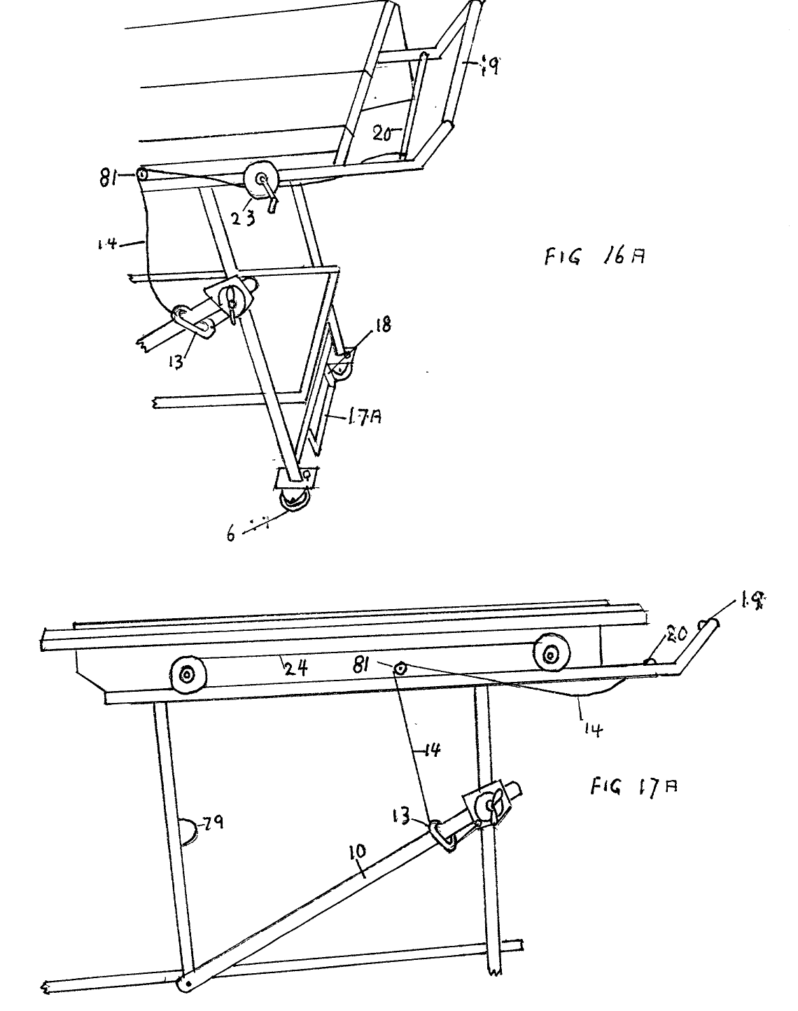

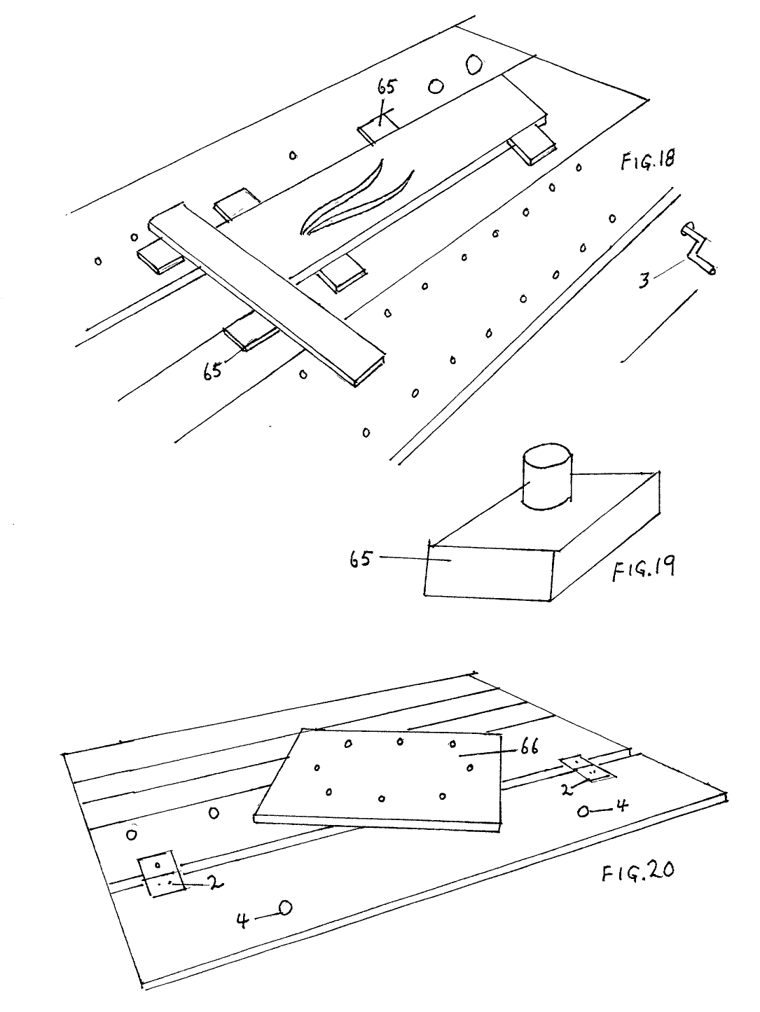

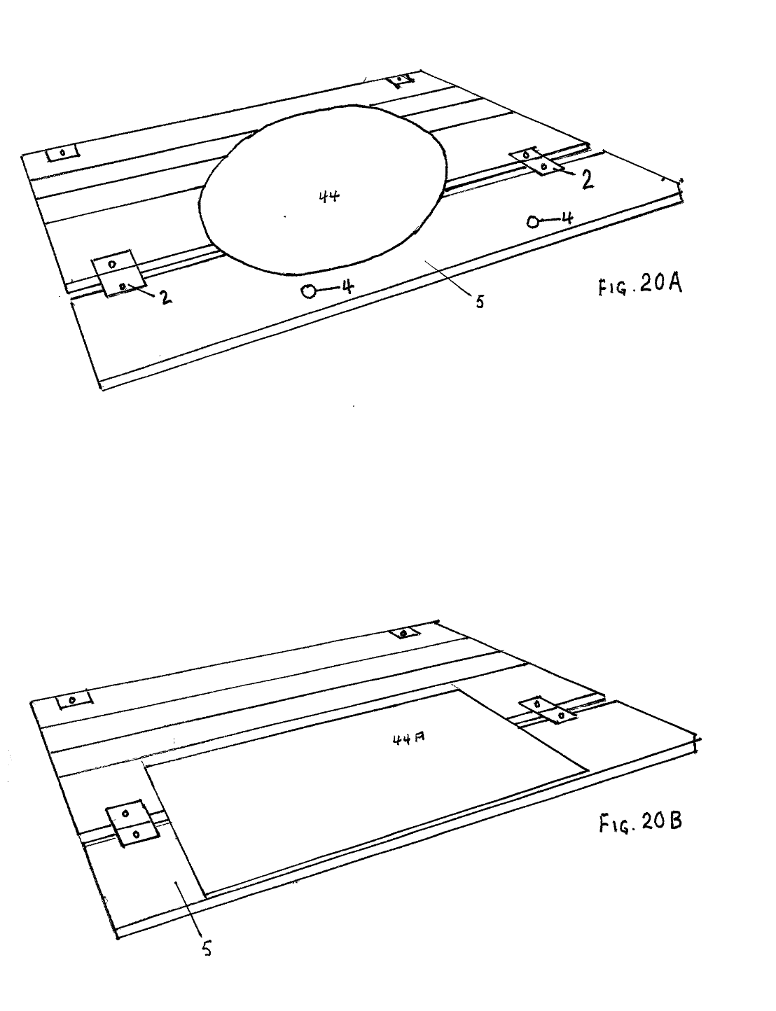

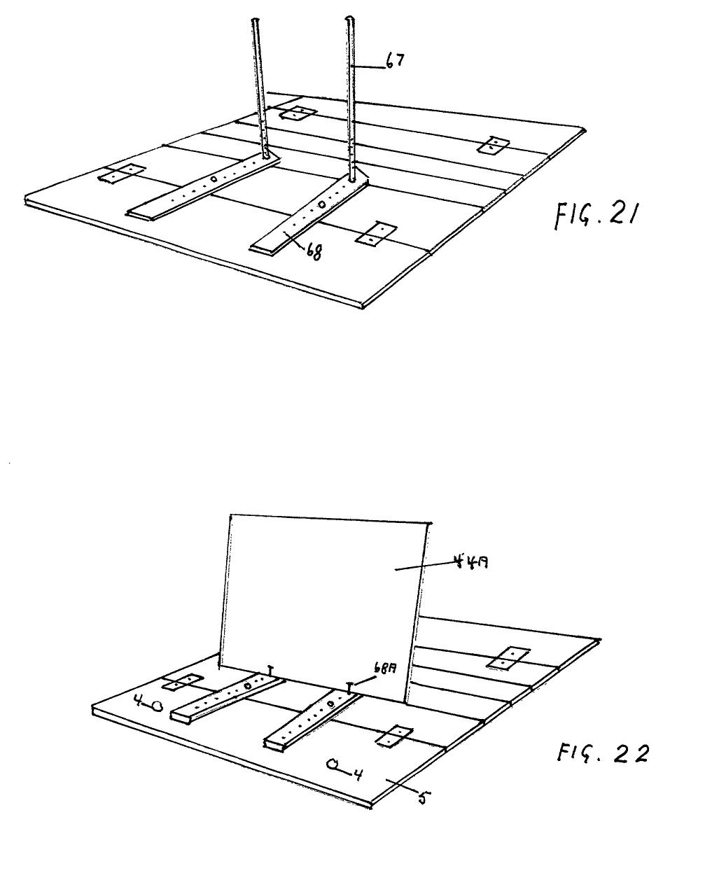

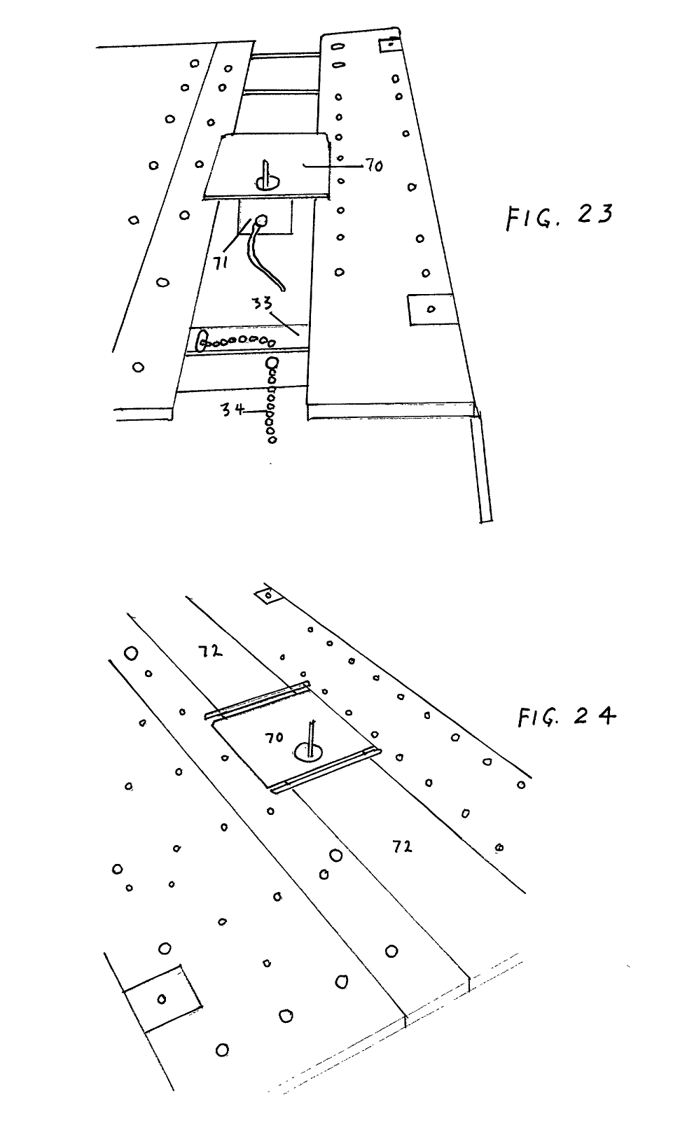

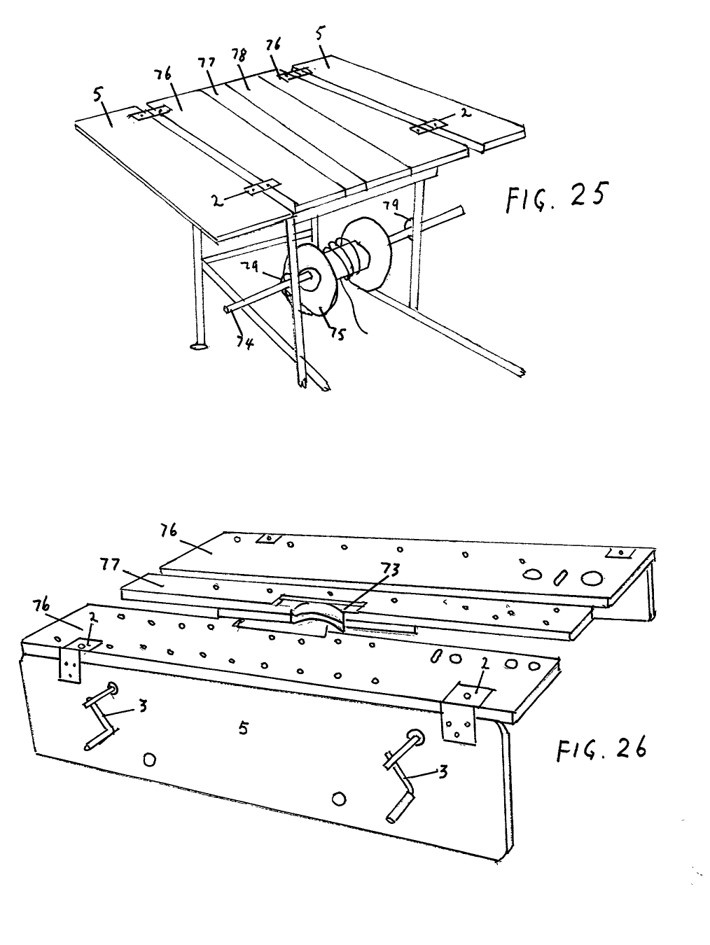

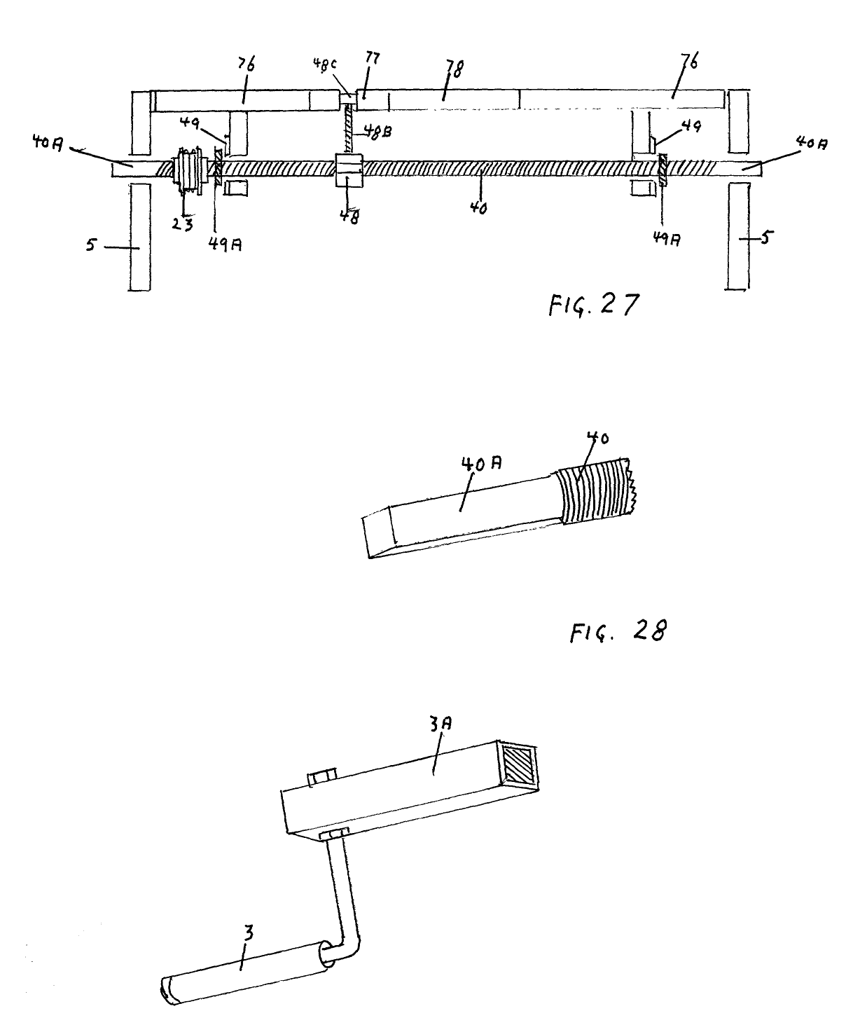

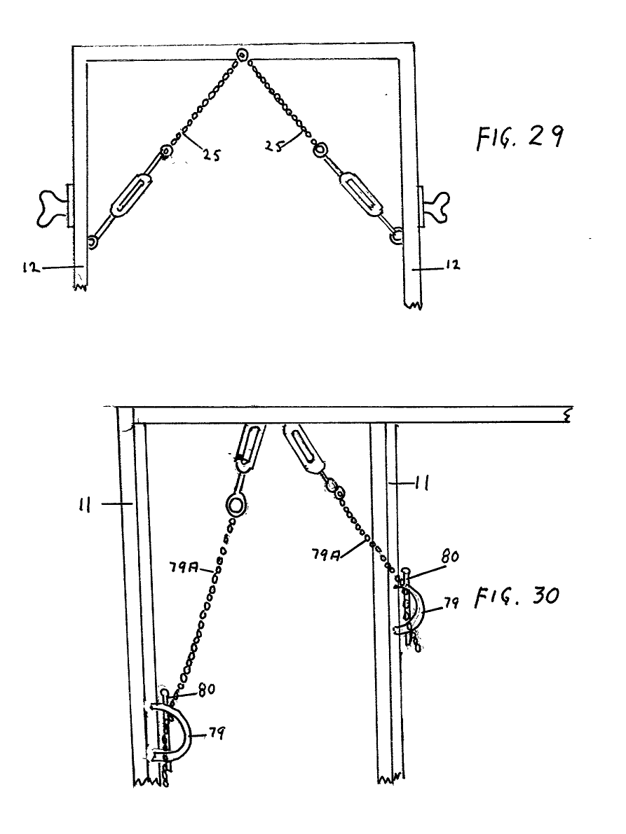

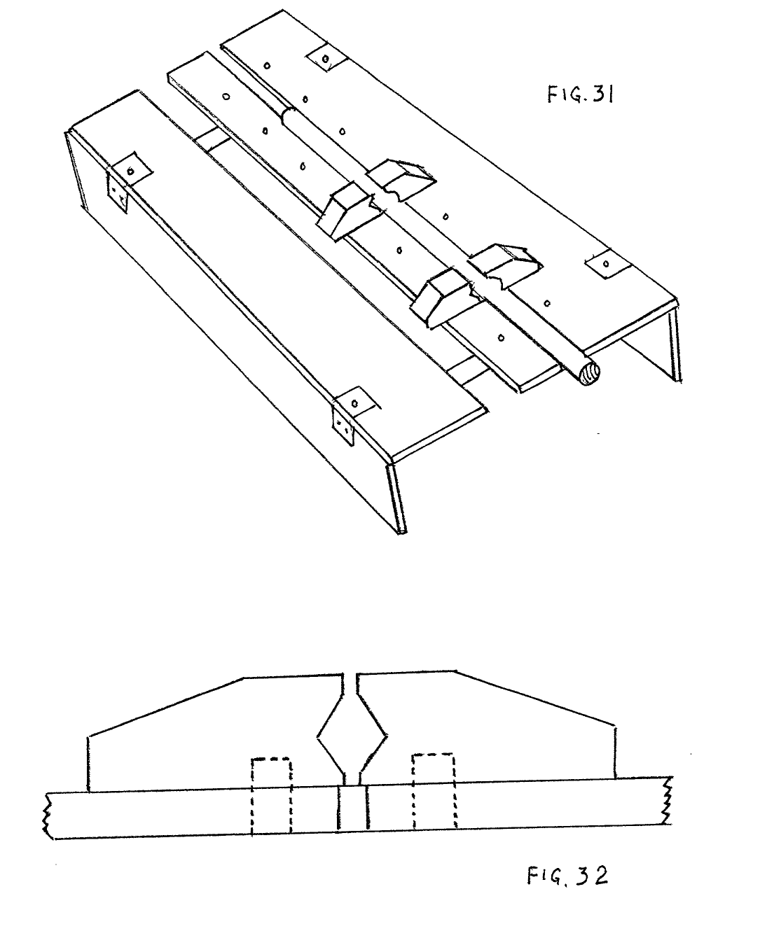

Auxiliary wooden jaws plug into table top holes, and used in conjunction with regular table top vise, will hold pipe ¾″ to 3″ for sawing.

The embodiments of the invention in which an exclusive property or privilege is claimed are defined as follows:

1. This Tool Table comprises of a sectional wooden table top, metal framework designed to hold a large tool box and one material tray. The table when in upright position moves about on 4 wheels, or can be folded to move about on the front wheels over rough ground, wheelbarrow fashion, or up and down stairs. The wooden table top has numerous holes and a moveable board forming the jaw portion of a full length vice. Vice and accessory jaws also hold pipe for cutting. The vice is operated by 2 hand cranks from either side or end. The table framework can be folded down on tool box, the table, tool box and wheels readily locked. In the upright working position provides a sturdy base for numerous tools and securely holds such tools as router, saber saw, miter box etc. There is also a removable board that performs numerous functions (see claim 12).
Common problems for the work force on a job site are . . .
1. Workmen are unable to have all their tools handy with them.
2. Need a sturdy bench to work on.
3. A means of locking their equipment when they leave . . . Locking takes about 1 minute.
I have found all the above problems are readily overcome by using the TOOL TABLE and its numerous features.
Tradesmen such as maintenance men in apartment buildings, hospitals, hotels, motels, apartment dwellers, hobbyists and artists will find its many functions of great value. Also available will be a heavy duty move for farm, industry and military use.

2. As defined in claim 1. Two threaded crank shafts are connected by a drive belt and one pulley on each shaft, this allows one hand free for holding work piece and one hand for cranking one work piece is held, tighten both detachable cranks.

3. As defined in claim 1 wooden table top has 2 drop leaf side wings which provide 8″ additional surface on both sides of the table and supported in place by pull out support rods. Wings being hollow, also act as scabbards for two full sized hand saws, one 36″ rule and one 2′ square.

4. As defined in claim 1 folded Tool Table can readily be moved on front two wheels, wheelbarrow fashion or in upright working mode on 4 casters, tools and tool box in place. On 4 casters is very maneuverable in hallways, elevators or confined spaces.

5. As defined in claim 1 tools such as router, skill saw, saber saw and hand tools can be securely locked in tool box by folding table on box and locking front wheels. This is done in about 1 minute by using a locking bar passing through table top chain, two caster loops and applying a padlock to locking bar.

6. As defined in claim 1 in upright working move table top is very solid on locked casters and provides a stable platform for accessories such as a metal vice, wood lathe, numerous holes to hold tools such as hammer, screw drivers, chisels, wrenches, drill, hold down clamps swivel desk lamp etc.

7. As defined in claim 1 the Tool Table framework in working mode can be locked safely in the upright position by turning two large wing nuts clockwise. Front casters are locked by stepping on the caster locking levers and tightening two caster eye bolts thus completely preventing any slack movement. By stepping on the back foot bar and pulling back on the hand bar, back casters are lifted off the floor. Table now stands on two solid adjustable feet that have continued automatically been locked in position by two D shaped fittings falling on a wedge on each back leg. This wedge and D fitting bind and eliminate all slack motion.

8. As defined in claim 1 the upright working position two wooden panels are placed in the lower framework forming two decks, an open top try goes in the back deck and a large tool box with hinged lid goes on the front deck. The back deck is to provide carrying space for paint cans, electricians wire spools and other tradesmen's supplies. The front deck provides space for a large tool box capable of holding tools such as skill saw, router, saber saw, drill, level and numerous hand tools. Box has moveable dividers and a removable try for small hand tools.

9. As defined in claim 1 to lock tools and entire table, close the box lid, lie hand saw handles on lid cover posts provided, turn the two wing nuts anticlockwise, grasp hand bar and with foot on foot bar and one finger on each hand pull back on the release bar and lower table down on box, pull chain from compartment on front of table, step on right and left caster locking levers pass locking bar through the right caster loop, through chain link, through left caster loop, fasten padlock through hole in end of front locking bar, tighten two caster eye bolts. Table and tools are made secure in about 1 minute. Workman can now go to lunch.

10. As defined in claim 1 Wooden Tool Table top is comprised of 6 pieces of ¾″ plywood the full length of the table made up as follows:
A. 2 hollow side drop leaf wings.
B. 2 solid boards fastened to table frame.
C. one removable board.
D. one moveable board that is the moveable jaw portion of the table top vise.
E. two filler boards for use with the router or saber saw . . . both are short boards.

11. As defined in claim 1 the moveable by crank board is the jaw of the table length vise, it is adjustable by turning crank handles from either side of the table or either end. Vertical surfaces of jaws covered with sand paper for very positive gripping.

12. As defined in claim 1 the removable board is a space filler when jaws not in use, it also provides optional mounting for a saber saw fastened by 2 bolts to the underside of the board. The board with

13. saw are now mounted between the table jaws. With the removable board out provides space for the saber saw or router to be firmly held by the vise jaws. This board has numerous holes to screw fasten from below to hold work piece solidly than place on table to be held by jaws. Oddly shaped pieces can be securely held for carving, routering, planing, sanding etc.

13. As defined by claim 1 numerous holes are present in table top boards for upright tool storage for screwdrivers, chisels, hammers, wrenches, pliers, drill, hold down clamps, clamping bumpers, and swivel desk lamp etc.

14. As defined in claim 1 Metal framework consists of ¾″ square tubing and ¾′ angle iron or aluminum.
Fixed portions welded.

15. In folded mode without storage boxes table occupies a small space, can be stored in a car trunk or standing on its front section can be stored in the clothes closet of an apartment dweller.

16. As defined in claim 1 to raise from folded horizontal position loosen two wing nuts, unlock front wheels, place foot on foot bar, lift hand bar, table will raise and automatically locks in upright position. Tighten the two safety wing nuts.
Function of the diagonal brace bar while raising table to upright position.
The diagonal brace bar has a deep notch toward the back end. On raising the table from folded mode the bars ride on horizontal back leg pins as they move. The notches as they reach the horizontal pins fall by gravity over and lock on the pins. Completely secure locking is done by tightening the two wing nuts thus removing all slack motion making the table very rigid. To lower to folded position loosen two wing nuts anticlockwise, place foot on foot bar, grasp hand bar with both hands, using one finger on each hand pull release bar and slowly lower table to tool box, or minus box all the way down to the bottomdeck. Lock two wing nuts by turning clockwise. Tighten two caster eye bolts to prevent swiveling. Make sure D fittings are in locked position and grasp hand bar to raise table to vertical position for moving on front wheels or storage in a small space standing on front framework.

17. As defined in claim 1 to take back legs off back casters put foot on the raised foot bar and force down to floor pulling hand bar at the same time toward you. This motion raises the casters off the floor automatically locking in position when D fitting falls down over the. To replace two back leg wedges, binding and preventing any slack movement. Tighten two wing nuts.

18. Stabilizing and bracing is done with chain and turnbuckles. The back chain and turn bucklesonce preset on assembly need no further attention. The forward stabilizers are only needed if vigorous work is to be done, using a hack saw, hand saw or rasp. Forward frame chain is fastened to each side on forward leg metal loops by dropping a pin through pin hole on loops and through chain. Now tighten turnbuckle. With turnbuckle tight and casters locked there is no slack movement. Table is now very rigid and ready for vigorous hand work.

19. As defined in claim 1 power tools such as router and saber saw are used in conjunction with a foot off-on switch leaving hands free to guide work.

20. As defined in claim 1 maintenance men such as electricians can use wire spools by mounting spools between front legs by passing a telescoping axle through metal loop on right leg, through spool then through loop on left leg, is secured by dropping a pin through pin holes in loops and pipe. Wire can now be reeled off as spool is free to rotate on axle, axle can accommodate 3 spools.

21. As defined in claim 1 when Tool Table in upright working position, tool box lid can be raised and fastens in the open position making tools readily accessible.

22. As defined in claim 1 procedure for locking Tool Table, tool box and front wheels, Tools such as router, belt sander, skill saw and hand tools can be securely locked in tool box by folding framework and tale down on tool box and locking front wheels.
Procedure for locking model A.
1. Loosen two wing nuts anticlockwise.
2. Place hand saw handles over tool box posts.
3. Lower table down on box.
4. Tighten caster eye bolts.
5. Step on caster locking levers.
6. Pull chain from chain locker in table front.
7. Pass locking bar through left caster loop, through chain in, then through right caster loop.
8. Attach padlock through hole in end of locking bar.
9. Tighten two large wing nuts.
Model B
Steps 1,2 and 3 same as for Model A.
4. Tighten two eye bolts down on wheel tires.
5. Pull chain from chain locker inn table front;
6. Pass locking bar through right eye bole, chain link then through left eye bolt.
7. Attach padlock through hole in end of locking bar.
Table, tool box and tools now secure. This procedure can be done in about 1 minute.

23. As defined in claim 1 the front lower deck panel can be used as an artists easel or writing surface. Velcro pads on table and panel hold it securely for a writing desk. Using two upright dowels set in table top holes and two horizontal bars with adjustable peg holes, panel converts into an artists easel. Additional table surface area is provided by raising drop side wings and pulling out 4 wing brace arms.

24. As defined in claim 1 vice crank shafts are two horizontal threaded rods extending the full width of the table top, mounted six inches from each end and lying two inches below table top. Threaded on the rods are two large long threaded nuts. Welded at right angles to the mid section of nuts are two threaded 5/16: bolts. These bolts extend from the nut to the top side of the tool table. They are attached and countersunk to the moveable jaw of the full length table top vise. Cranking the rods causes these long nuts to travel right or left on the threaded shafts thus moving the moveable jaw of the table top vise. The cranking action closes the jaw thereby securely holding power tools such as router, saber saw and pieces to be worked on. A two inch pulley is attached to each shaft and joined by a belt, therefore cranking one shaft moves both shafts, leaving one hand free to hold work while clamping in vise. There is enough slippage between belt and pulleys to allow jaw to close on unparallel work pieces, final tightening is down by turning cranks by hand separately until jaw is tight on work piece or power tool.

25. As defined in claim 1 an attachable square board 12″×12″×¾″ with fastening holes and center peg on under side fits into table top holes. This board can swivel and be locked in any position using table and board holes with a peg or clamp. On this board can be placed potter clay or sculpture material to be worked. Work piece can be rotated as needed. This square board by two d\sided carpet tape the disc provides a smooth surface to facilitate drawing or tracing. Friction between board and table makes for a steady but readily rotated surface.

26. Just beneath the table top on the back framework is fastened a 6 outlet power bar providing easy access for power tools and a swivel table lamp.

27. As defined in claim 1 pipe ¾″ and under can be held by regular table top vise jaws. Pipe over ¾″ to 3″ can be held by 4 wooden auxiliary vise jaws plugged into holes on the fixed table top board and vise jaw board. Turning crank handles tightens jaws on pipe for sawing.
